(19) United States
(12) Patent Application Publication
(10) Pub. No.: US 2013/0187567 A1
(43) Pub. Date: Jul. 25, 2013

(54) CAPACITIVE LOAD DRIVING APPARATUS AND METHOD THEREOF

(71) Applicant: Chih-Ping Li, Singapore (SG)

(72) Inventor: Chih-Ping Li, Singapore (SG)

(73) Assignee: FSP TECHNOLOGY INC., Taoyuan County (TW)

(21) Appl. No.: 13/557,216

(22) Filed: Jul. 25, 2012

(30) Foreign Application Priority Data
Jul. 25, 2011 (TW) 100126174

(51) Int. Cl. H02M 7/217; H05B 37/02; H02M 7/02

(52) U.S. Cl. CPC H02M 7/2176; H02M 7/02; H05B 37/02
USPC 315/297; 363/21.01; 363/15; 307/31

(57) ABSTRACT

A load driving apparatus and a method thereof are provided. The provided load driving apparatus includes a first rectification unit, a first conversion unit and a second conversion unit. The first rectification unit is configured to receive and rectify an AC voltage, so as to output a first DC voltage. The first conversion unit is coupled to the first rectification unit, and is configured to receive and convert the first DC voltage, so as to output a second DC voltage. The first conversion unit is further configured to adjust the second DC voltage according to a feedback signal relating to the second DC voltage. The second conversion unit is coupled to the first conversion unit, and is configured to receive and convert the second DC voltage, so as to output a third DC voltage with a constant current to drive a first capacitive load.

### CROSS-REFERENCE TO RELATED APPLICATION

This application claims the priority benefit of Taiwan application serial no. 100126174, filed on Jul. 25, 2011. The entirety of the above-mentioned patent application is hereby incorporated by reference herein and made a part of this specification.

### BACKGROUND OF THE INVENTION

1. Field of the Invention

The present invention relates to a load driving technology, more particularly, to a load driving apparatus suitable for capacitive loads (for example, light emitting diodes (LEDs)) and a method thereof.

2. Description of the Related Art

FIG. 1 is a diagram of a conventional LED driving apparatus 100. Referring to FIG. 1, the LED driving apparatus 100 includes a rectification unit 110 and two driving modules 120 and 130. The rectification unit 110 is configured to perform a rectification on a received AC voltage AC_IN. The driving modules 120 and 130 respectively provide, in response to the output of the rectification unit 110, the driving voltages V_{BUS1} and V_{BUS2} to drive the LED loads 150 and 160. In general, the driving module 120 would adjust the driving voltage V_{BUS1} according to the feedback signal relating to the current of the LED load 150, and the driving module 130 would adjust the driving voltage V_{BUS2} according to the feedback signal relating to the current of the LED load 160, such that the LED loads 150 and 160 can stably and respectively provide the desired light source brightness.

However, under the driving configuration of FIG. 1, the ripple of the currents respectively flowing through the LED loads 150 and 160 may have a larger swing, so the light sources respectively provided by the LED loads 150 and 160 may have flicker. On the other hand, the number of the driving modules in the LED driving apparatus 100 increases as the number of the LED loads increases, and therefore, the cost of the LED driving apparatus 100 increases as the number of the LED loads increases.

### SUMMARY OF THE INVENTION

Accordingly, in order to solve the above-mentioned problem, an exemplary embodiment of the invention provides a load driving apparatus including a first rectification unit, a first conversion unit and a second conversion unit. The first rectification unit is configured to receive and rectify an AC voltage, so as to output a first DC voltage. The first conversion unit is coupled to the first rectification unit, and is configured to receive and convert the first DC voltage, so as to output a second DC voltage. The first conversion unit is further configured to adjust the second DC voltage according to a feedback signal relating to the second DC voltage. The second conversion unit is coupled to the first conversion unit, and is configured to receive and convert the second DC voltage, so as to output a third DC voltage with a constant current to drive a first capacitive load.

In an exemplary embodiment of the invention, the provided load driving apparatus may further include a third conversion unit. The third conversion unit is coupled to the first conversion unit, and is configured to receive and convert the second DC voltage, so as to output a fourth DC voltage with a constant current to drive a second capacitive load.

In an exemplary embodiment of the invention, each of the first and the second capacitive loads may have at least a light emitting diode (LED).

In an exemplary embodiment of the invention, the first conversion unit may include a power factor correction (PFC) converter, an isolation transformer, a power switch, a second rectification unit, a feedback unit and a PFC-PWM (power factor correction-pulse width modulation) controller. The PFC converter is coupled to the first rectification unit, and is configured to perform a power factor correction on the output of the first rectification unit in response to a correction signal. The isolation transformer has a primary side and a secondary side, wherein a first terminal of the primary side of the isolation transformer is coupled to an output of the PFC converter.

The power switch is coupled between a second terminal of the primary side of the isolation transformer and a dangerous ground, wherein the power switch is switched in response to a PWM signal. The second rectification unit is coupled to the secondary side of the isolation transformer, and is configured to output the second DC voltage. The feedback unit is coupled to the second rectification unit, and is configured to provide the feedback signal in response to the second DC voltage. The PFC-PWM controller is coupled to the PFC converter, the power switch and the feedback unit, and is configured to provide the correction signal to the PFC converter in response to the feedback signal. The PFC-PWM controller is further configured to provide the PWM signal to the power switch in response to the feedback signal, so as to switch the power switch, and thus adjusting the second DC voltage.

In another exemplary embodiment of the invention, the first conversion unit may include an isolation transformer, a power switch, a second rectification unit, a feedback unit and a PFC-PWM controller. The isolation transformer has a primary side and a secondary side, wherein a first terminal of the primary side of the isolation transformer is coupled to the output of the first rectification unit. The power switch is coupled between a second terminal of the primary side of the isolation transformer and a dangerous ground, wherein the power switch is switched in response to a PWM signal. The second rectification unit is coupled to the secondary side of the isolation transformer, and is configured to output the second DC voltage. The feedback unit is coupled to the second rectification unit, and is configured to provide the feedback signal in response to the second DC voltage. The PFC-PWM controller is coupled to the output of the first rectification unit, the power switch and the feedback unit, and is configured to provide the PWM signal to the power switch in response to the feedback signal and the first DC voltage, so as to switch the power switch, and thus performing a power factor correction on the output of the first rectification unit and adjusting the second DC voltage.

Another exemplary embodiment of the invention provides a load driving method. The provided load driving method includes: providing a first DC voltage by rectifying an AC voltage; providing a second DC voltage by converting the first DC voltage, and adjusting the second DC voltage according to a feedback signal relating to the second DC voltage; and providing a third DC voltage with a constant current by converting the second DC voltage to drive a first capacitive load.

In an exemplary embodiment of the invention, the provided load driving method may further include: providing a fourth DC voltage with a constant current by converting the second DC voltage to drive a second capacitive load.

From the above, in the invention, the driving voltages respectively for driving the capacitive loads are adjusted by the voltage feedback configuration, such that the problem of flickering, in case that the LED loads are traditionally driven under the current feedback configuration, can be effectively solved by the provided load driving apparatus under the voltage feedback configuration. On the other hand, in the invention, the provided load driving apparatus can be extended to an application or implementation for driving multi-levels capacitive load under a single first conversion unit is used, such that by comparing the load driving apparatus under the voltage feedback configuration with the conventional LED driving apparatus under the current feedback configuration, the cost of the load (LED) driving apparatus can be substantially reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional light emitting diode (LED) driving apparatus.

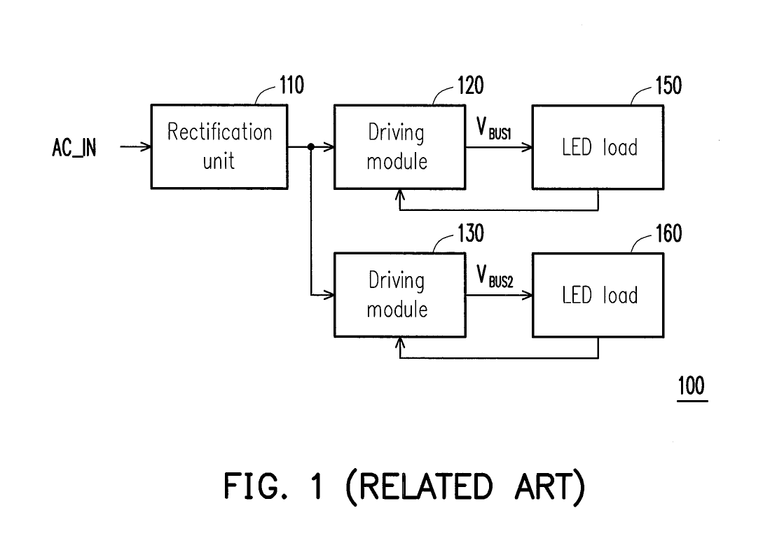

FIG. 2 is a diagram of a load driving apparatus according to an exemplary embodiment of the invention.

FIG. 3 is a diagram of a first rectification unit in FIG. 2.

FIGS. 4A, 4B and 4C are respectively a diagram of capacitive loads according to various exemplary embodiments.

FIG. 5 is a flowchart of a load driving method according to an exemplary embodiment of the invention.

FIG. 6 is a diagram of a load driving apparatus according to another exemplary embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

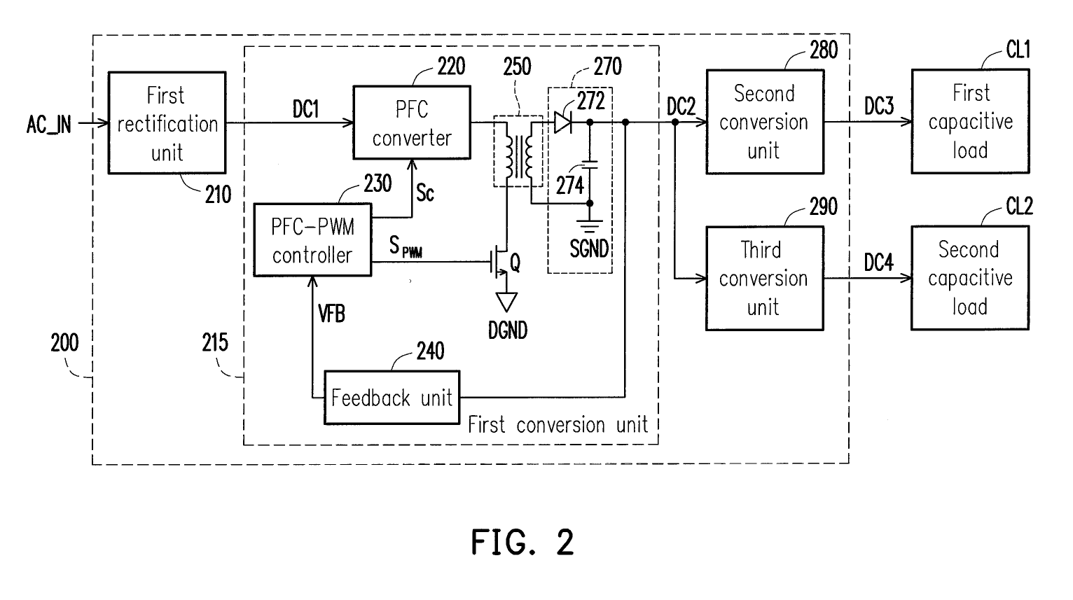

FIG. 2 is a diagram of a load driving apparatus 200 according to an exemplary embodiment of the invention. Referring to FIG. 2, the load driving apparatus 200 may include a first rectification unit 210, a first conversion unit 215, a second conversion unit 280 and a third conversion unit 290. The first conversion unit 215 is coupled between the first rectification unit 215, the second conversion unit 280 and the third conversion unit 290. In this exemplary embodiment, the first rectification unit 210 is configured to receive an AC voltage AC_IN (for example, a city power, but not limited thereto), and perform a rectification on the received AC voltage AC_IN, so as to output a first DC voltage DC1.

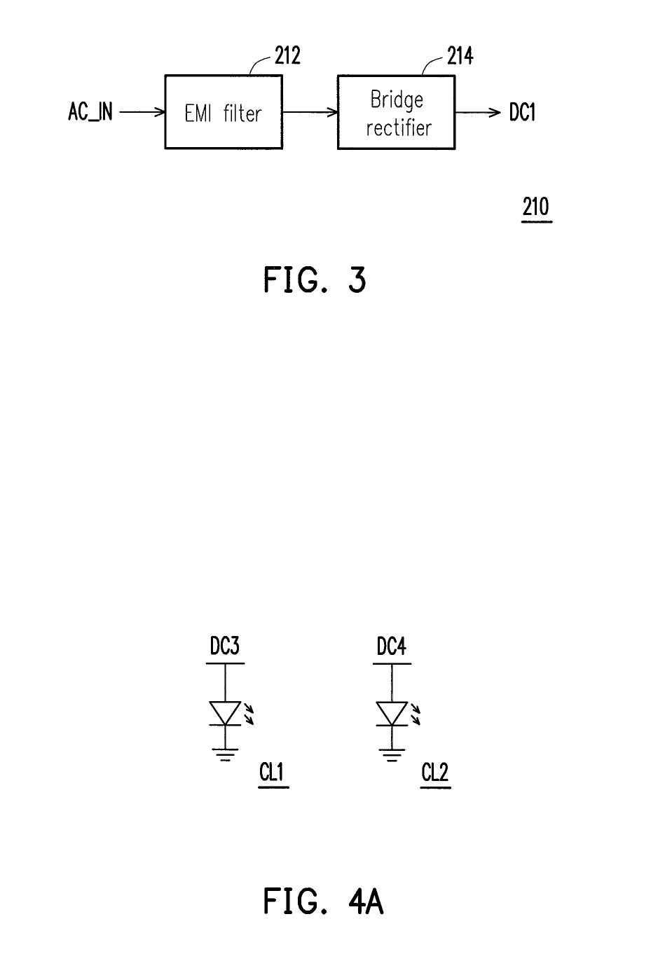

To be specific, FIG. 3 is a diagram of the first rectification unit 210 in FIG. 2. Referring to FIGS. 2 and 3, the first rectification unit 210 may include an electromagnetic interference (EMI) filter 212 and a bridge rectifier 214. The EMI filter 212 is coupled between the AC voltage AC_IN and an input of the bridge rectifier 214, and is configured to suppress an electromagnetic noise of the AC voltage AC_IN. The bridge rectifier 214 is configured to receive the AC voltage AC_IN from the EMI filter 212, and to perform a full-wave rectification on the received AC voltage AC_IN, so as to output the first DC voltage DC1.

The first conversion unit 215 is configured to receive and convert the first DC voltage DC1, so as to output a second DC voltage DC2. Moreover, the first conversion unit 215 is further configured to adjust the second DC voltage DC2 according to a feedback signal VFB relating to the second DC voltage DC2. The configuration of the first conversion unit 215 will be explained in later.

The second conversion unit 280 is configured to receive and convert the second DC voltage DC2, so as to output a third DC voltage DC3 with a constant current to drive a first capacitive load CL1. Similarly, the third conversion unit 290 is configured to receive and convert the second DC voltage DC2, so as to output a fourth DC voltage DC4 with a constant current to drive a second capacitive load CL2. Obviously, each of the second conversion unit 280 and the third conversion unit 290 can be implemented by a DC-to-DC converter topology, but not limited thereto.

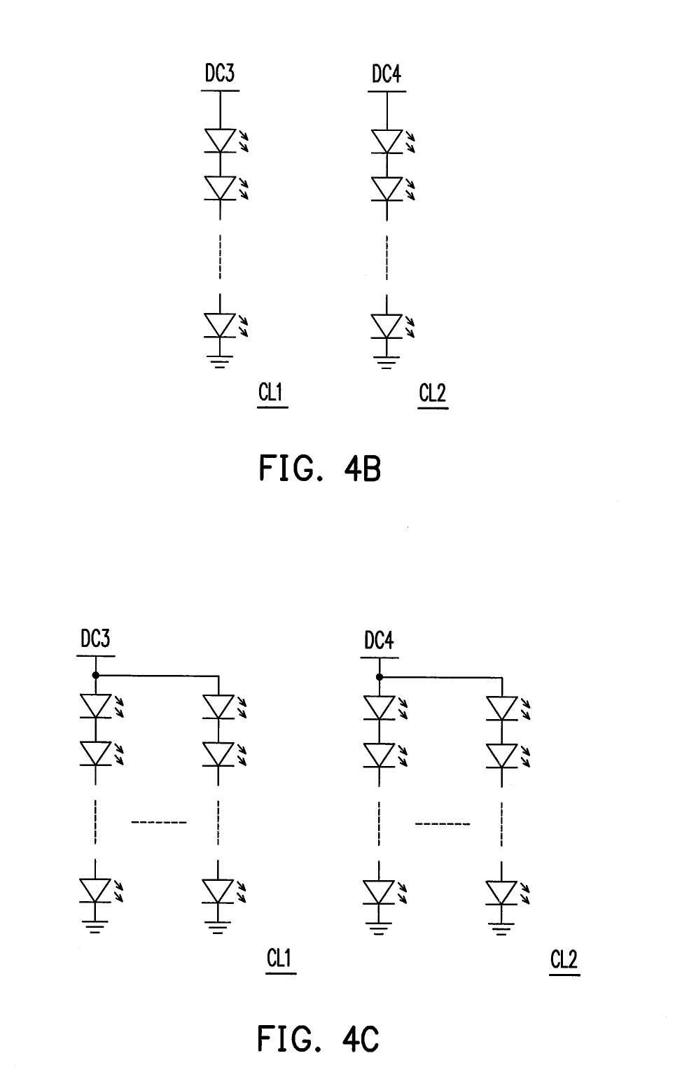

It is noted that each of the first capacitive load CL1 and the second capacitive load CL2 both driven by the load driving apparatus 200 may include at least a light emitting diode (LED). In other words, each of the first capacitive load CL1 and the second capacitive load CL2 may include a single LED as shown in FIG. 4A. OR, each of the first capacitive load CL1 and the second capacitive load CL2 may include a plurality of LEDs connected in series to form an LED string as shown in FIG. 4B. OR, each of the first capacitive load CL1 and the second capacitive load CL2 may include a plurality of LED strings connected in parallel as shown in FIG. 4C. The implementation of each of the first capacitive load CL1 and the second capacitive load CL2 can be determined by the real design or application.

In this exemplary embodiment, the first conversion unit 215 may include a power factor correction (PFC) converter 220, an isolation transformer 250, a power switch Q, a second rectification unit 270, a feedback unit 240 and a PFC-PWM (power factor correction-pulse width modulation) controller 230. The PFC converter 220 is coupled to the first rectification unit 210, and is configured to perform a power factor correction on the output of the first rectification unit 210 in response to a correction signal Sc.

The isolation transformer 250 has a primary side and a secondary side, wherein a first terminal of the primary side of the isolation transformer 250 is coupled to an output of the PFC converter 220. The power switch Q is coupled between a second terminal of the primary side of the isolation transformer 250 and a dangerous ground DGND. The power switch Q is switched in response to a PWM signal S_{PWM}. In this exemplary embodiment, the power switch Q is implemented by an N-type power switch, for example, an NMOS power transistor, but not limited thereto.

The second rectification unit 270 is coupled to the secondary side of the isolation transformer 205, and is configured to output the second DC voltage DC2. In this exemplary embodiment, the second rectification unit 270 may be a half-wave rectification circuit which is composed of a diode 272 and a capacitor 274. An anode of the diode 272 is coupled to a first terminal of the secondary side of the isolation transformer 250, and a cathode of the diode 272 is configured to output the second DC voltage DC2. A first terminal of the capacitor 274 is coupled to the cathode of the diode 272, and a second terminal of the capacitor 274 is coupled to a second terminal of the secondary side of the isolation transformer 250 and a safety ground SGND.

The feedback unit 240 is coupled to the second rectification unit 270, and is configured to provide the feedback signal VFB in response to the second DC voltage DC2, where the feedback signal VFB is a voltage signal. In this exemplary embodiment, the feedback unit 240 may be a voltage dividing circuit or a photo-coupler feedback circuit, but not limited thereto. The PFC-PWM controller 230 is coupled to the PFC converter 220, the power switch Q and the feedback unit 240, and is configured to provide the correction signal Sc to the PFC converter 220 in response to the feedback signal VFB, so as to make the PFC converter 220 perform the power factor correction on the output of the first rectification unit 210. The PFC-PWM controller 230 is further configured to provide the PWM signal S_{PWM} to the power switch Q in response to the feedback signal VFB, so as to switch the power switch Q, and thus adjusting the second DC voltage DC2.

In this exemplary embodiment, when the second DC voltage DC2 is lower than a predetermined value, the PFC-PWM controller 230 would provide the PWM signal S_{PWM} with larger duty cycle to switch the power switch Q in response to the feedback signal VFB provided from the feedback unit 240; otherwise, when the second DC voltage DC2 is higher than the predetermined value, the PFC-PWM controller 230 would provide the PWM signal S_{PWM} with smaller duty cycle to switch the power switch Q in response to the feedback signal VFB provided from the feedback unit 240. Accordingly, in response to the variation of the feedback signal VFB, the second DC voltage DC2 can be stably kept at the predetermined value by adjusting the duty cycle of the PWM signal S_{PWM} provided from the PFC-PWM controller 230.

From the above, the load driving apparatus 200 of this exemplary embodiment can adjust the driving voltages respectively for driving the capacitive loads CL1, CL2 (i.e. the third and the fourth DC voltages DC3, DC4 respectively generated by the second and the third conversion units 280, 290) under the voltage feedback configuration (i.e. the voltage feedback signal VFB relating to the second DC voltage DC2). Furthermore, due to the DC-to-DC converter has a characteristic of stably providing the DC voltage and current, such that the problem of flickering, in case that the LED loads are traditionally driven under the current feedback configuration, can be effectively solved by the load driving apparatus 200 under the voltage feedback configuration.

On the other hand, the load driving apparatus 200 of this exemplary embodiment can be extended to an application or implementation for driving multi-levels capacitive load under a single first conversion unit 215 is used. In other words, two-level capacitive loads CL1, CL2 are taken as an example to be simultaneously driven by the load driving apparatus 200 shown in FIG. 2, but if the load driving apparatus 200 would drive two more capacitive loads, for example, three-level capacitive loads, only an additional fourth conversion unit (not shown) needs to be added into the load driving apparatus 200, so as to convert the second DC voltage DC2 into a fifth DC voltage (DC5, not shown) to drive a third capacitive load (not shown). As taught by such contents, three more capacitive loads simultaneously driven by the load driving apparatus 200 in the other exemplary embodiments can be inferred or analogized by one person having ordinary skilled in the art, so the details thereto would be omitted. Obviously, the load driving apparatus 200 can be extended to an application or implementation for driving multi-level capacitive loads under a single first conversion unit 215 is used, such that by comparing the load driving apparatus 200 under the voltage feedback configuration with the conventional LED driving apparatus under the current feedback configuration, the cost of the load (LED) driving apparatus 200 can be substantially reduced.

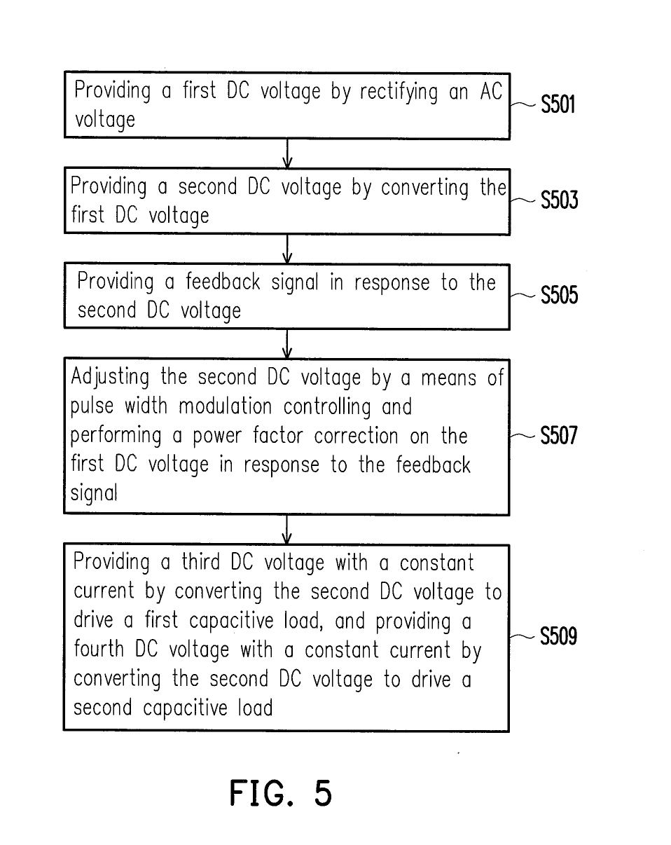

On the basis of the teachings or disclosures of the above exemplary embodiments, a general load driving method can be submitted. To be specific, FIG. 5 is a flowchart of a load driving method according to an exemplary embodiment of the invention. Referring to FIG. 5, the load driving method of the exemplary embodiment includes the following steps of:

Providing a first DC voltage by rectifying an AC voltage (S501);

Providing a second DC voltage by converting the first DC voltage (S503);

Providing a feedback signal in response to the second DC voltage (S505), namely, by using the voltage feedback manner;

Adjusting the second DC voltage by a means of pulse width modulation controlling and performing a power factor correction on the first DC voltage in response to the feedback signal (S507), namely, PFC+PWM; and

Providing a third DC voltage with a constant current by converting the second DC voltage to drive a first capacitive load (for example, at least one LED), and (simultaneously) providing a fourth DC voltage with a constant current by converting the second DC voltage to drive a second capacitive load (for example, at least one LED) (S509).

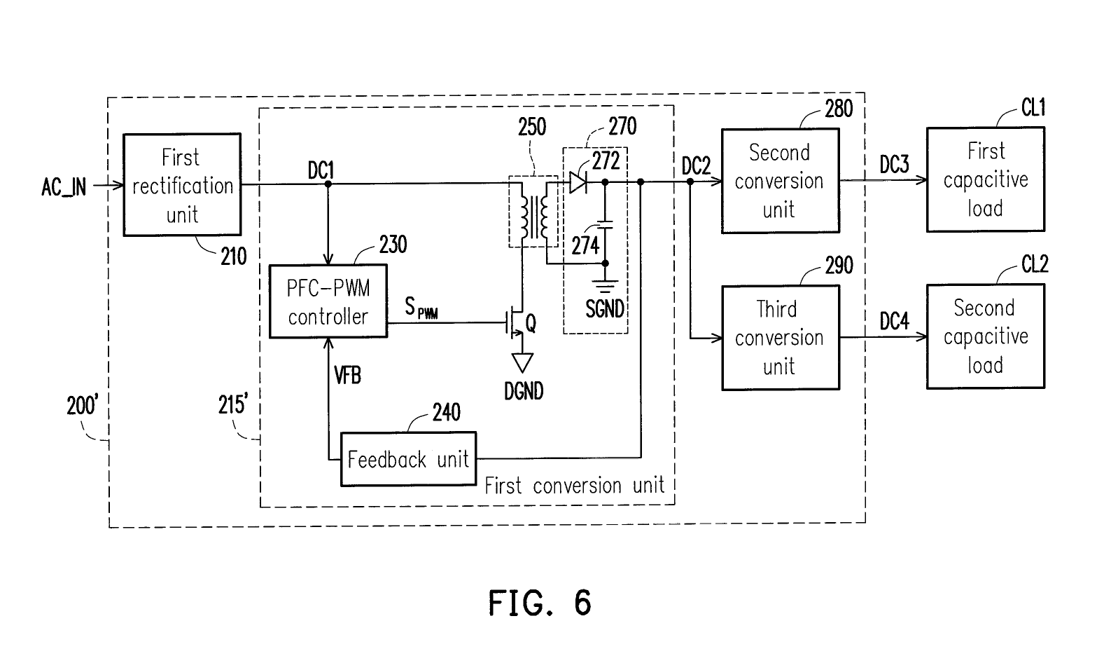

On the other hand, FIG. 6 is a diagram of a load driving apparatus 200′ according to another exemplary embodiment of the invention. Referring to FIGS. 2 and 6, the difference between the FIGS. 2 and 6 is only that the configuration of the first conversion unit 215′ of FIG. 6 is different from that of the first conversion unit 201 of FIG. 2. To be specific, the first conversion unit 215′ as shown in FIG. 6 does not include the PFC converter 220 as shown in FIG. 2, and the PFC-PWM controller 230 is at least capable of performing the power factor correction and the pulse width modulation (i.e. PFC+PWM).

In this case, the isolation transformer 250 as shown in FIG. 6 similarly has the primary side and the secondary side, wherein the first terminal of the primary side of the isolation transformer 250 as shown in FIG. 6 is coupled to the output of the first rectification unit 210. The power switch Q as shown in FIG. 6 is similarly coupled between the second terminal of the primary side of the isolation transformer 250 and the dangerous ground DGND, and is similarly implemented by the N-type transistor, for example, the NMOS power transistor, but not limited thereto. The power switch Q as shown in FIG. 6 is similarly switched in response to the PWM signal S_{PWM} from the PFC-PWM controller 230.

The second rectification unit 270 as shown in FIG. 6 is similarly coupled to the secondary side of the isolation transformer 250, and is configured to output the second DC voltage DC2. In this exemplary embodiment, the configuration of the second rectification unit 270 as shown in FIG. 6 is the same as that of the FIG. 2, namely, the half-wave rectification circuit which is composed of the diode 272 and the capacitor 274.

The feedback unit 240 as shown in FIG. 6 is similarly coupled to the second rectification unit 270, and is configured to provide the feedback signal VFB in response to the second DC voltage DC2. In this exemplary embodiment, the feedback unit 240 similarly may be the voltage dividing circuit or the photo-coupler feedback circuit, but not limited thereto. The PFC-PWM controller 230 as shown in FIG. 6 is coupled to the output of the first rectification unit 210, the power switch Q and the feedback unit 240, and is configured to provide the PWM signal S_{PWM} to the power switch Q in response to the feedback signal VFB and the first DC voltage DC1, so as to switch the power switch Q, and thus performing the power factor correction on the output of the first rectification unit 210 and adjusting the second DC voltage DC2.

The conception or principle of FIG. 6's exemplary embodiment is substantially the same as that of FIG. 2's exemplary embodiment, so the details thereto would be omitted.

In summary, in the invention, the driving voltages respectively for driving the capacitive loads are adjusted by the voltage feedback configuration, such that the problem of flickering, in case that the LED loads are traditionally driven under the current feedback configuration, can be effectively solved by the provided load driving apparatus under the voltage feedback configuration. On the other hand, in the invention, the provided load driving apparatus can be extended to an application or implementation for driving multi-level capacitive loads under a single first conversion unit is used, such that by comparing the load driving apparatus under the voltage feedback configuration with the conventional LED driving apparatus under the current feedback configuration, the cost of the load (LED) driving apparatus can be substantially reduced.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A load driving apparatus, comprising:
a first rectification unit, configured to receive and rectify an AC voltage, so as to output a first DC voltage;
a first conversion unit, coupled to the first rectification unit, configured to receive and convert the first DC voltage, so as to output a second DC voltage, wherein the first conversion unit is further configured to adjust the second DC voltage according to a feedback signal relating to the second DC voltage; and
a second conversion unit, coupled to the first conversion unit, configured to receive and convert the second DC voltage, so as to output a third DC voltage with a constant current to drive a first capacitive load.

2. The load driving apparatus according to claim 1, wherein the first conversion unit comprises:
a power factor correction (PFC) converter, coupled to the first rectification unit, configured to perform a power factor correction on the output of the first rectification unit in response to a correction signal;
an isolation transformer, having a primary side and a secondary side, wherein a first terminal of the primary side is coupled to an output of the PFC converter;
a power switch, coupled between a second terminal of the primary side and a dangerous ground, wherein the power switch is switched in response to a pulse width modulation (PWM) signal;
a second rectification unit, coupled to the secondary side, configured to output the second DC voltage;
a feedback unit, coupled to the second rectification unit, configured to provide the feedback signal in response to the second DC voltage; and
a PFC-PWM controller, coupled to the PFC converter, the power switch and the feedback unit, configured to provide the correction signal to the PFC converter in response to the feedback signal, wherein the PFC-PWM controller is further configured to provide the PWM signal to the power switch in response to the feedback signal, so as to switch the power switch, and thus adjusting the second DC voltage.

3. The load driving apparatus according to claim 2, wherein the second rectification unit comprises:
a diode, having an anode coupled to a first terminal of the secondary side, and a cathode outputting the second DC voltage; and
a capacitor, having a first terminal coupled to the cathode of the diode, and a second terminal coupled to a second terminal of the secondary side and a safety ground.

4. The load driving apparatus according to claim 2, wherein the power switch is an N-type power switch.

5. The load driving apparatus according to claim 1, wherein the first conversion unit comprises:
an isolation transformer, having a primary side and a secondary side, wherein a first terminal of the primary side is coupled to the output of the first rectification unit;
a power switch, coupled between a second terminal of the primary side and a dangerous ground, wherein the power switch is switched in response to a pulse width modulation (PWM) signal;
a second rectification unit, coupled to the secondary side, configured to output the second DC voltage;
a feedback unit, coupled to the second rectification unit, configured to provide the feedback signal in response to the second DC voltage; and
a PFC-PWM controller, coupled to the output of the first rectification unit, the power switch and the feedback unit, configured to provide the PWM signal to the power switch in response to the feedback signal and the first DC voltage, so as to switch the power switch, and thus performing a power factor correction on the output of the first rectification unit and adjusting the second DC voltage.

6. The load driving apparatus according to claim 5, wherein the second rectification unit comprises:
a diode, having an anode coupled to a first terminal of the secondary side, and a cathode outputting the second DC voltage; and
a capacitor, having a first terminal coupled to the cathode of the diode, and a second terminal coupled to a second terminal of the secondary side and a safety ground.

7. The load driving apparatus according to claim 5, wherein the power switch is an N-type power switch.

8. The load driving apparatus according to claim 1, wherein the first rectification unit comprises:
a bridge rectifier, configured to receive the AC voltage, and perform a full-wave rectification on the AC voltage, so as to output the first DC voltage.

9. The load driving apparatus according to claim 8, wherein the first rectification unit further comprises:
an electromagnetic interference (EMI) filter, coupled between the AC voltage and the bridge rectifier, configured to suppress an electromagnetic noise of the AC voltage.

10. The load driving apparatus according to claim 1, wherein the first capacitive load comprises at least a light emitting diode (LED).

11. The load driving apparatus according to claim 1, further comprising:
a third conversion unit, coupled to the first conversion unit, configured to receive and convert the second DC voltage, so as to output a fourth DC voltage with a constant current to drive a second capacitive load.

12. The load driving apparatus according to claim 11, wherein the second capacitive load comprises at least an LED.

13. A load driving method, comprising:
providing a first DC voltage by rectifying an AC voltage;
providing a second DC voltage by converting the first DC voltage, and adjusting the second DC voltage according to a feedback signal relating to the second DC voltage; and
providing a third DC voltage with a constant current by converting the second DC voltage to drive a first capacitive load.

14. The load driving method according to claim 13, further comprising:
providing a fourth DC voltage with a constant current by converting the second DC voltage to drive a second capacitive load.

15. The load driving method according to claim 13, wherein the step of adjusting comprises:
providing the feedback signal in response to the second DC voltage; and
adjusting the second DC voltage by a means of pulse width modulation controlling in response to the feedback signal.

16. The load driving method according to claim 15, further comprising:
performing a power factor correction on the first DC voltage in response to the feedback signal.
